(19) United States
(12) Patent Application Publication
(10) Pub. No.: US 2013/0019449 A1
(43) Pub. Date: Jan. 24, 2013

(54) Customized Item and Method for Beverage Identification and Personal Expression

(71) Applicant: Larysa Didio, Brewster, NY (US)

(72) Inventor: Larysa Didio, Brewster, NY (US)

(21) Appl. No.: 13/524,181

(22) Filed: Jun. 15, 2012

Related U.S. Application Data
(63) Continuation of application No. 12/040,118, filed on Feb. 29, 2008, now abandoned.
(60) Provisional application No. 60/892,684, filed on Mar. 2, 2007.

(51) Int. Cl. B23P 11/00

(52) U.S. Cl. 29/428

(57) ABSTRACT

A band and identity item for attachment to a beverage container. Both band and identity item serve to identify the beverage container. The band is formed to allow for expansion to fit securely around a beverage container. The identity item employs an attachment mechanism to allow for frequent and easy interchangeability of identity items. The method includes customizing the band and identity item to allow for maximum personal expression to serve as the identification means.

### CLAIM OF PRIORITY

To the extent applicable, the present invention claims the benefit of the priority of U.S. Provisional Application Ser. No. 60/892,684, filed Mar. 2, 2007, the contents of which are incorporated by reference herein.

### FIELD OF THE INVENTION

This invention relates to a detachable item used to simultaneously adorn and identify a beverage container and a method for providing a customization of the item. More particularly, an elasticized or adjustable band is attached to a removable and interchangeable charm that may be customized and affixed to a beverage container.

### BACKGROUND OF THE INVENTION

With the success and resulting prevalence of bottled water, it is not uncommon for people to carry a bottle wherever they go, often refilling the same bottle throughout the day. In addition, the limited number of large-scale bottled water producers results in many people carrying identical bottles. An office break room could lead to a number of identical bottles and inevitable confusion as could a gym locker room. In fact everyday presents a number of situations where it may be convenient to distinguish a beverage container from a room full of similar containers. The present invention serves the dual purpose of not only insuring the ability to identify one's water bottle, but simultaneously serving to decorate and individualize an item that is often carried everywhere.

U.S. Pat. No. 5,358,770 (Evans) discloses a detachable, flexible plastic device to be attached to a beverage container for identification purposes. The device exists in a semi-circular form while the flexible plastic material allows for slight expansion of the semi-circle for attachment and detachment from the beverage container. The device also includes magnets at each terminating end for easy storage on metal surfaces, such as a refrigerator.

U.S. Pat. No. 5,704,144 (Groth) discloses a thin, flexible tag for attachment to a beverage container. The tag includes a display area where a writing utensil can be used to write a name or other symbol. The tag is held in place by a tacky adhesive that allows for one end of the tag to be affixed to the other end of the tag allowing for snug fit on any size beverage container.

U.S. Pat. No. 6,086,702 (Rea) discloses a label for attachment to a beverage container. The label contains a set of detachable stickers, usually letters, to be removed from the larger label and attached to a new location on the beverage container so as to identify the beverage container, for example, with one's name.

U.S. Pat. No. 6,293,034 (Skapyak et al.) discloses a decorative, solid ring for placement on a beverage container, usually a wine bottle. Attached to the solid ring are a number of smaller, decorative rings that can be detached and reattached for use on other, smaller beverage containers, usually wine glasses.

U.S. Design Pat. No. D501,625 (Biggerstaff) discloses a ring for attachment to a beverage container. An identification tag is attached to the ring.

Additional items of potential interest include U.S. Pat. No. 6,615,517 (King) and U.S. Pat. No. 1,360,229 (Kolstad).

These previous inventions fill the need for identification but not for individualization. Since the water bottle has become a constant accessory, it is only natural that an individual may wish to adorn the water bottle in some way that identifies their individuality, just as they would with a purse or a watch. The present invention fulfills the need for both identification of a beverage container and ornamentation of the beverage container for personal expression.

### SUMMARY OF THE INVENTION

This invention relates to a detachable item used to simultaneously adorn and identify a beverage container and a method for providing a customization of the item. The item employs a band or wrap that can be adjusted for fit. The band or wrap may be continuous or have two terminating ends. The terminating ends may employ a fastener. The band or wrap can be constructed of any number of materials including plastic, natural fiber, fur, feather, cotton, neoprene, rubber, or neoprene.

The band may also contain a means for attachment to an additional item for purposes of identification and self-expression. The item is a design and/or identity element that may be a charm, a tag, a jewel, a picture or any combination thereof to identify a beverage container. The item may be fastened to the band such that it can be attached or detached while the band remains affixed to the beverage container for ease of interchangeability of the identity item.

Most water bottles are configured with a number of ridges that form circular grooves around the outside of the bottle. The band may be configured to fit within one of these grooves. This fit has one or more benefits such as facilitating secure placement of the band to avoid unwanted movement of the band along the bottle, preventing wear on the band and preventing any packaging issues, should a bottled water producer choose to attach the bands prior to distribution and sale.

In a first aspect, the present invention meets one or more of the above needs by providing an improved method for uniquely identifying a beverage container, comprising the steps of a) providing an attachment mechanism to a beverage container; b) providing a customizable unique identifier for placement on the attachment mechanism; and c) displaying the attachment mechanism, the unique identifier or both.

The method may be further characterized by one or any combination of the following features: the attachment mechanism consists of two terminating ends intended for attachment to one another; the unique identifier is interchangeable with additional unique identifiers; the attachment mechanism is elasticized, pliable, adjustable, or any combination thereof; the attachment mechanism allows for a large enough width to encompass a beverage container at the beverage container's widest point; the attachment mechanism includes at least one of a band, a strap, a sleeve, a wrapping or any combination thereof; the attachment mechanism is either continuous or non-continuous with a means for clasping; the continuous attachment mechanism includes at least one of an elastic band, an elastic sleeve, a terry cloth wrap, or any combination thereof; the non-continuous attachment mechanism includes at least one of a strap including a hook and loop fastener, a band with hook and loop fasteners, an adhesion fastener (e.g., VELCRO™), a strap including adjoining a male and a female fastener or any combination thereof; the method further comprises placing the attachment mechanism on a beverage container; the attachment mechanism further comprises a means to allow for manual adjustment of the attachment mechanism's length; the beverage container is a bottle of water; the method further comprises permanently or temporarily placing the unique identifier on the attachment mechanism; the unique identifier is placed on the attachment mechanism via a detachable fastening means; the detachable fastening means is adapted to permit interchangeability of various unique identifiers with the attachment mechanism, and is interchanged with one or more of such various unique identifiers; the detachable fastening means is either magnetic, composed of a male part affixed to either the band or the identity item and a female part affixed to the opposing end, a hook-shaped clasp fastened to either the band or the identity item which links through a circular piece attached to the opposing end, a ridged or threaded opening and an opposingly ridged and threaded insert, a threaded screw mechanism, a flexible plural-prong clip with arms for temporarily narrowing the clip for insertion into complimentary attachment site having openings for receiving the plural-prong clip, or any combination thereof; the fastening means includes a barrel-type assembly such that either magnetism or friction maintains one end of the fastener within the other end of the fastener and detachment occurs by applying a pre-determined tension to overcome the magnetic or frictional force; the unique identifier is at least one of a charm, a tag, a jewel, a picture, a or any combination thereof; the unique identifier is engraved; the unique identifier is laser engraved; the attachment mechanism and/or the unique identifier is screen printed; the attachment mechanism and/or the unique identifier is ink-jet printed; the unique identifier is either flat, arcuate, arbitrary in shape, predetermined in shape, or any combination thereof; the unique identifier is customized by a machine; the unique identifier is customized at a remote location separate from a purchaser; the unique identifier is customized at a retail point of sale location; or the unique identifier emits a sound.

In another aspect of the invention, there is contemplated a method of (i) displaying any of the fore-mentioned beverage container identifier components or assemblies (of the first aspect of the invention described in the above paragraphs); (ii) offering a beverage container for sale (with or without a contained beverage), comprising the steps of : a) providing an attachment mechanism that is placed on a beverage container; b) providing a customizable unique identifier for placement on the attachment mechanism; and c) displaying the attachment mechanism, the unique identifier or both (e.g., at a retail point of sale).

The method of this aspect of the invention may be further characterized by one or any combination of the following features: the displaying step is performed with: a) the attachment mechanism and unique identifier attached to the beverage container during manufacture; b) the attachment mechanism attached to the beverage container during manufacture and the unique identifier displayed and sold separately; c) the attachment mechanism and the unique identifier displayed together as one unit, separately from the beverage container; or d) the attachment mechanism and the unique identifier displayed separately from one another and from the beverage container; the displaying step is performed at a sporting goods retail outlet, a convenience store, a coffee shop, a department store, a jewelry store, a gym pro-shop, or any similar retail outlet; the displaying step is performed via an internet website wherein a selection of attachment mechanisms and the unique identifiers are displayed both together and separately; the displaying step is performed by allowing point-of-sale customization of the attachment mechanisms and unique identifiers; the displaying step is performed by containing the bands and identity items in a portable display that facilitates temporary or permanent attachment to a counter, a wall, a rack or the like; the displaying step is performed by containing the bands and identity items in a box or the like, within separate partitions, wherein transparent lids allow viewing of each partition; or the displaying step is performed by containing the bands and identity items within separate partitions, wherein opaque lids are adorned with an example of the band or identity item contained within each partition.

### BRIEF DESCRIPTION OF THE DRAWINGS

FIGS. 1A, 1B and 1C are views of an attachment mechanism and identity item attached to a beverage container at various locations on the beverage container.

FIG. 2 is a perspective of one illustrative example of the invention.

FIG. 3 is a view of an identity item.

FIG. 4 is a view of a point of purchase display for identity items.

FIG. 5 is a perspective of one illustrative example of the invention.

### DESCRIPTION OF THE PREFERRED EMBODIMENT

The invention employs an attachment mechanism 1 in the form of an elasticized band or wrap, a pliable band or wrap, an adjustable band or wrap, or any combination thereof, that can be adjusted for fit according to the size of any given beverage container 18 or alternative attachment site. The band may be composed of a single material or of multiple materials. In one preferred embodiment, the band may include a core/shell configuration wherein a first material is covered by a second, different material (e.g. such as that attained by covering an elastomeric core with a woven or un-woven covering). A band material (e.g. plastics, natural fibers such as hemp, jute or sisal) may also be impregnated with a material for preserving its freshness, such as carbon particles. The band may or may not include elastic. The band may have a constant cross-sectional profile or one that changes along its length. The band may have curved edges or sharp edges or a combination of curved and sharp edges. The cross section of the band may be circular, rectangular, oval, heart-shaped, trapezoidal or any other shape.

The length or circumference of the band may be larger than the width of the band or alternatively, the band width may be greater than the circumference of the band and thereby extend over a larger portion of a bottle. The circumference of the band may be at a predetermined size such as the circumference of a standard bottle. In one preferred embodiment, the diameter of the band is preferably between 1.5 and 2.5 inches or more preferably, between 2 and 2.25 inches. The circumference of the band is preferably between 6.5 and 8.5 inches or more preferably between 7.5 and 8 inches. The width of the band is preferably between 0.05 and 6.0 inches is more preferably between 0.1 and 1 inch. The circumference of the band may also be adjustable to a point that does not permit slippage from a bottle. The adjustability of the band may be automatic, such as an elastic formed band, or may be manual, requiring a user to adjust the band based upon the size of a beverage container. The width of the band may also be adjustable.

Preferably, the band may be flat, round or an alternative homogeneous or non-homogenous shape. The band may range in width from less than 1 cm to the length of the beverage container. In a preferred embodiment, the band can be one continuous portion of material 2, relying on elasticity for attachment and detachment, or a member 3 with two terminating ends. The terminating ends may include a clasping means 4 to allow for the ends to be securely fastened while still allowing for adjustable size capability depending on the size of the beverage container. In a preferred embodiment, to facilitate attachment of the terminating ends, the clasping means may include one male 5 and one female 6 portion. Preferably, one terminating end may be a hook portion, while the other terminating end contains a small circle for insertion of the hook. Both terminating ends may be magnets to allow for magnetic attachment.

In one preferred embodiment, the band may also contain a mechanism 7 to allow for shortening or lengthening of the band. The band itself may also contain a decorative identifying element 8 in the form of a name, phrase, or design printed, attached and/or embroidered directly on the band. Preferably, the band may also include adhered design elements such as jewels, pictures, beads or the like. The band can be constructed of any number of materials including plastic, natural fibers, fur, feather, cotton, neoprene, terry cloth, rubber, foam or any combination thereof. Preferably, the band may be composed of rubber, formed by extrusion of a rubber tube that is subsequently cut into uniform or non-uniform rings.

In one preferred embodiment, the band also contains a means for attachment 9 to an identifier 10 for purposes of identification and self-expression. The item is an identity element that may be a charm, a tag, a jewel, a picture or any combination thereof that can identify a beverage container. The identity element may also contain a complimentary means for attachment 11 to the band. In a preferred embodiment, the item may also include a bell mechanism, a programmable audible sound device, or tuned material so as to incorporate a desired sound as the identity item moves and contacts other identity items or the beverage container itself. The identity item may also include a “mood” jewel, or a thermochromic material that can change color when exposed to different temperatures or different amounts of light. In one preferred embodiment, the identity item may simply be a tag with a clear plastic covered envelope that allows for different items or words to be slipped into and out of the plastic envelope, so as to be visible from the outside of the tag. In another preferred embodiment, the band and/or the identity item can be constructed from recycled materials or made of materials that can later be recycled. The identity item may also be any combination of these or any similar items.

Another preferred embodiment of the present invention may include an audible signal emitted at any time the beverage container is moved, so as to alert the owner if the container may be in the wrong hands.

In a preferred embodiment of the present invention, the identity item is connected to the band via any suitable means. Preferably, the method of attachment will allow for ease of interchangeability, inconspicuous attachment means, durability and/or security. Preferably, the identity item will be fastened to the band such that it can be attached or detached while the band remains affixed to the beverage container for ease of interchangeability of the identity item. It is also imperative that the identity item is securely attached to the band in order to prevent inadvertent loss of the identity item.

Any number of fastening means may be employed to facilitate attachment of the identity item to the attachment means, such as those disclosed in U.S. Pat. No. 5,729,877 (Kong et al.), U.S. Pat. No. 6,615,460 (Baumgarten), U.S. Pat. No. 6,826,806 (Eaton et al.), U.S. Pat. No. 6,073,317 (Barison), U.S. Pat. No. 6,161,266 (Anscher) and U.S. Patent Publication No. 2003/0033697 (Hicks et al.) incorporated herein by reference. These fastening means employ various buckles, connectors, and breakaway devices that allow for secure and yet simple attachability and detachability. Baumgarten discloses a fastener that attaches by inserting a male end into a female receiving end and detaches by simultaneously pinching both sides of the male end. Eaton et al. disclose a hermaphroditic clip, wherein both ends have complimentary male and female sides allowing for secure attachment and simple detachment.

The mechanism for fixture of the identity item to the band may be a magnet within a barrel-type assembly, wherein a first portion of a magnet is affixed to the band as the fastening device and the second portion of the magnet is affixed to the identity item. The fixation means may also be composed of a male part affixed to either the band or the identity item and a female part affixed to the opposing end. In one preferred embodiment, the identity item may also be attached via a hook-shaped clasp fastened to either the band or the identity item, which links through a circular piece attached to the opposing end. The fastening means may also be a breakaway device 22, wherein one side 23 of the fastener is slightly smaller than the opposing side 24 of the fastener, such that the friction fit between each end allows for secure attachment and subsequent detachment with the application of a predetermined tension to overcome the frictional force.

Preferably, the fastening system can be formed of planar or tubular plastic (e.g. an extruded profile), where the attachment site on the band provides a ridged and/or threaded opening and/or the design element contains an opposingly ridged and/or threaded insert that allows for inter-connection of the ridges or threads when the identity item insert is placed into the attachment site opening. The identity item can be removed by any action that disengages the inter-connected ridges. Fastening may also employ a hook and loop type fastener.

The fastening means may also be composed of threaded screw mechanism, where the design element is attached to a screw-type piece that can be inserted into a circular, threaded tube-shaped site attached to the band. Preferably, the identity item may be affixed with a flexible plural-prong clip 12 and the band affixed with an attachment site 13 having an opening 14 for insertion of the prongs, wherein the distance between the prongs is wider than the diameter of the conical attachment site. It will be appreciated from the depiction in FIG. 3, that the arms material 15 can be deformed relative to each other to close gap and keep the identity item secure. It may be possible that the fastening means will twist upon itself, so that it can be opened and reclosed (e.g. it may have one or more helical twisted ends that can be brought together to keep the identity item secure). The attachment site may be fitted with multiple grooves designed to receive the prongs from the identity item, such that each prong has a terminating end containing a horizontal piece no larger that the radius of the cylindrical attachment site, pointing into the opposing prong to allow for secure attachment to the cylindrical attachment site.

In one preferred embodiment, the identity item is affixed with a cylinder-shaped piece and the band is affixed with two flexible, circular clips wherein each clip is discontinuous, allowing for the entry and exit of the cylinder-shaped piece. Preferably, the cylinder-shaped piece has circular grooves at each point where the circular clips will contact the cylinder-shaped piece, such that the clips will slide into the grooves to prevent slipping and promote secure attachment to the band.

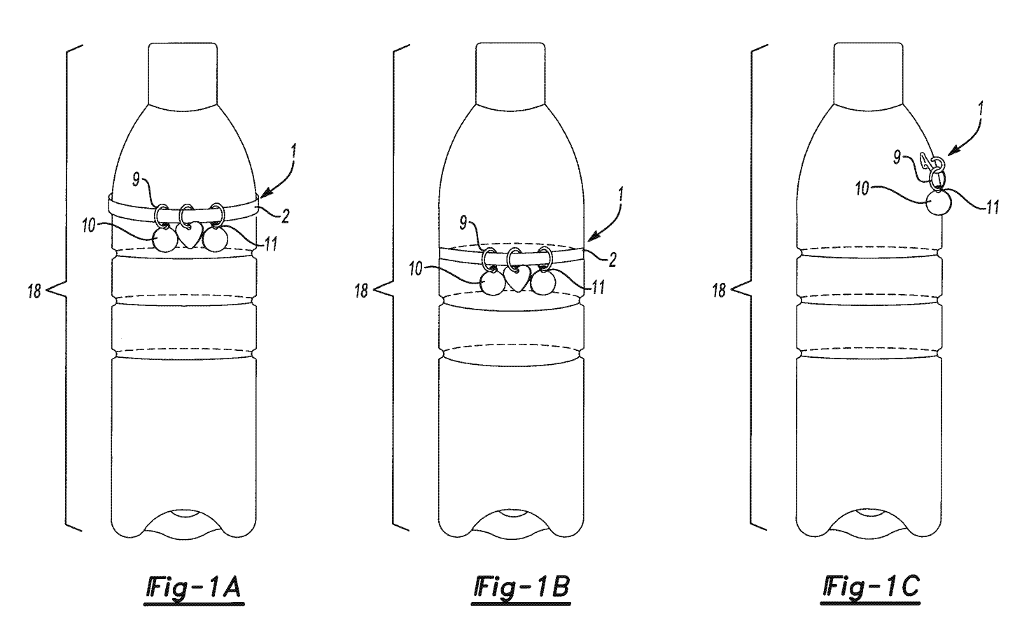

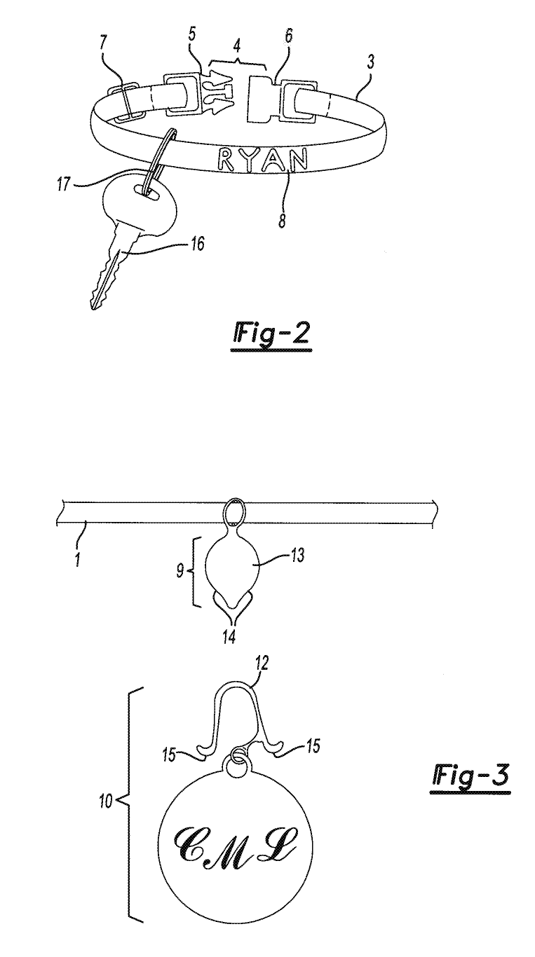

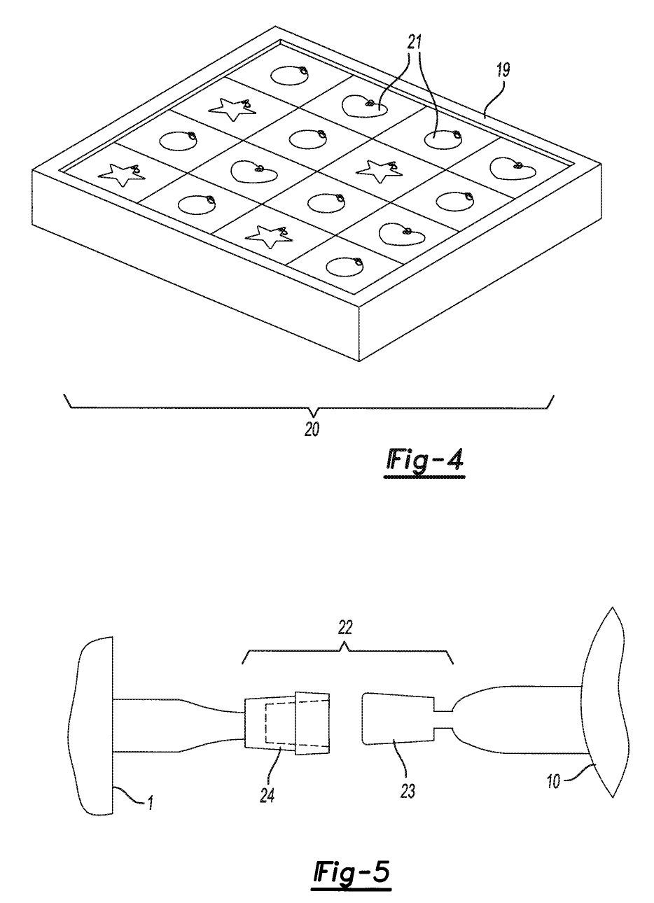

As represented in FIG. 1C, it is also possible that the attachment mechanism 1 can be integrally formed in a bottle. For example, during blow molding or some other molding operation, a ring, a handle, or some other appendage defining a aperture may be formed to project outwardly from a wall of the bottle so that the unique identifier can be attached to such appendage (e.g., by passing a portion of its associated structure through the aperture).

In a preferred embodiment of the present invention, the band will also permit the attachment of additional items to the beverage container such as car keys 16, locker keys, sunglasses, a change purse, mp3 player or other commonly carried convenience items. The band could also be fitted with a key-chain 17, clasp or hook to assist in facilitating the attachment of these items. In one preferred embodiment, the band may also be fitted with threaded clips or beads to prevent the sliding of the identity items or other convenience items, if desired. It may also be preferred that the identity item be allowed to slide freely along the band to achieve a desired sound, look, or feel.

In one preferred embodiment, once these convenience items are attached, it is beneficial for the band to allow transfer from a beverage container to another surface, such as a stroller handle, a bike seat, a key chain, a belt or the like. To allow for this transfer, the band may be affixed with an additional attachment mechanism that facilitates attachment to the stroller handles, bike seat, key chain, belt, or the like. This attachment mechanism may be composed of a hook, an elasticized band, a pinch-operated clasp, or any other autonomous attachment mechanism that does not require an added attachment site to the stroller handle, bike seat, key chain, belt or the like.

The bands and identity items can be adapted for a particular age group or a particular customer type. Preferably, the identity items for children may include cartoon characters, toy logos and brightly colored bands. An upscale identity item could include crystals or gemstones. A men's identity item may include a carabiner, such as those of a type used for rock climbing. Preferably, the bands and identity items aimed at a particular customer type will be displayed for purchase at stores that specialize in goods for a particular customer type. For example, bands and identity items designed for children may be displayed for purchase at toy stores, while bands and identity items designed specifically for women may be sold at makeup or lingerie shops. The bands and identity items may be presented in a self-contained display in a designated section of a retail facility. Preferably the bands and identity may be displayed among other, similar accessories such as sunglasses, key chains, jewelry or the like. The bands and identity items may also be displayed at the check-out counter to attract impulse purchasers.

In one preferred embodiment, the identity item can be manufactured and sold with the band or separately to allow an individual to purchase one band and multiple identity items for ease and interest of frequent interchangeability. Preferably, the identity items may be sold separately in a point-of-sale display 20, similar to a display for watches, sunglasses or other personal accessories. The display system may be a flat, glass and/or plastic covered case, where each band and identity item is displayed separately. Preferably, the display system may be an upright carousel-style rack that allows prospective purchasers to turn the display while viewing the various bands and identity items.

The display system may also be composed of metal, allowing for the bands and/or identity items to be magnetically attached to the display. The display may also incorporate a sensor that provides a signal to a cash register or sales person when a band or identity item is removed from the display, allowing purchasers easy access to the bands and identity items, yet preventing theft that may occur with such small items.

Preferably, the display system may be a flat or angled partitioned box 19, wherein each partition contains stock of one type of band or identity item. The lid or multiple lids of the box may be translucent to allow a prospective purchaser to view how much stock, if any, exists for a given band or identity item. The lid or multiple lids of the box may also be opaque, requiring a prospective purchaser to open a partition of box to view the inventory. The box display may also include example drawings or actual items 21 attached to the lid of each partition to designate the type of band or identity item located within a particular partition.

Preferably, the display system may be easily transportable within a given retail outlet or among a number of retail outlets. The display system may have an adhesive backing that allows for easy fixture to a temporary wall or counter. Preferably the display system will contain a latch mechanism, possibly with a lock, to allow for secure, temporary or permanent attachment to a checkout counter, a rack, a wall, or the like.

Preferably, the types of identity items available via the point-of-sale display may vary depending on the type of customer likely to shop in a given store. For example, the more athletic-style bands and identity items may be for sale at a sporting goods store or gym pro-shop, while a more expensive identity item such as a birthstone may be sold only at an upscale department store.

In a preferred embodiment of the present invention, the bands and identity items are also a vehicle for corporate promotions. For example, a retail store could sell the bands with the store name imprinted on the band. A beverage company could make silver charms spelling the beverage name. Celebrities, such as musicians (e.g., a rock band) could sell a band with the celebrity likeness, a source indicator such as a band's logo and/or some other ornamental feature (such as a musical instrument (e.g. guitar)) attached.

In a preferred embodiment of the present invention, a bottled water producer could attach a band during manufacture and either include an identity item with the band or allow for separate purchase of the identity item. As added benefit to the bottled water producer, the identity item could be the producer's logo, or a promotional article. The producer could also use the band and identity item as a vehicle for a contest, making the lucky finder of a specific identity item the contest winner.

In another preferred embodiment, a purchaser may also use a point-of-sale kiosk to choose and design their own, unique, customized identity item and/or band. The point-of-sale kiosk may be located within a store or within a mall and may be capable of providing instant custom bands and identity items. The point-of-sale kiosk may provide a finite number of choices for band color, band design, identity item color, identity item design and the like. The identity item could include a picture of a pet, a child's initials, a birthstone or a multitude of other items. A purchaser could specify material, color, shape, sound, size and any other aspect of the identity item design. The point-of-sale kiosk may be equipped with a printing mechanism, such as an inkjet printer, that allows for custom printing directly onto the bands or identity items. The point-of-sale kiosk may also be pre-filled with a pre-determined stock of certain color, style, size, and material of bands and identity items such that a purchaser wishing to customize their product would be limited to what may be available within the kiosk at the time of sale.

In another preferred embodiment, the band and identity item could also be customized to be given away as a party favor for a wedding, a birthday party, a bar mitzvah or the like. For example, the band could be imprinted with the wedding date, and the identity item could be a charm of a first state (e.g. Texas) and a charm of a second state (e.g. New York), representing the home state of both the bride and groom.

A preferred embodiment of the present method allows for customizing a band and/or identity item via the internet. The steps would include displaying a home page and prompting a user to advance to one or more pages for selecting an item size, item material, item color, fastener type, item monogramming, or any combination. When a user selects “band material” they will be presented with a list of options that may include leather, silk, neoprene, organza, polyester, natural fibers, recycled materials, carbon composite, elasticized natural fibers, rubber, beaded, or plastic. This process will continue until all possible parameters of the custom band and identity item have been chosen. As a customer is making the selections the web site may be visually displaying the selection, either as an individual feature, as part of an entire assembled band and identity item or both. In this manner, a customer may be able to view the intended product. Of course, the entire transaction, including payment, billing and shipping notices can be conducted over a secure site.

In another preferred embodiment, the methods herein contemplate a business by which purchasers may re-cycle their identity items. Thus an internet website may offer for sale a previously-used identity item as one of its features.

Various other features may be employed in the teachings herein. For example, an attachment mechanism may be configured to fit within a peripheral groove of a bottle so that the outer surface of the band and attachment mechanism is generally co-planar with or recessed relative to the adjoining bottle surface above and/or below the attachment mechanism. In this manner, it may be possible to pre-wrap a plurality of bottles, each with an attachment mechanism and have immediately adjacent bottles in contact with each other with or without their respective attachment mechanisms being in contact with each other.

In a preferred embodiment, the band is not designed to engage a flexible label that surrounds a bottle, nor is the band intended to slide freely along the length of the bottle. The band is not formed of a partial circle and is free of any adhesive material.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention, should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations and arrangements are also possible as will be gleaned from the following claims, which are also hereby incorporated by reference into the written description. The use of terms such as “first”, “second”, “a” or “an” does not preclude the presence of additional items.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

What is claimed is:

1. A method for uniquely identifying a beverage container, comprising the steps of:
a) providing an attachment mechanism as a continuous or non-continuous band of material, with no interruption or opportunity for fracture; and
b) providing a portion of a fastening means that is permanently affixed to the attachment mechanism for attachment to a unique identifier.

2. A method according to claim 1, wherein the attachment mechanism consists of two terminating ends intended for attachment to one another.

3. A method according to claim 1, wherein the unique identifier is interchangeable with additional unique identifiers.

4. A method according to claim 2, wherein the attachment mechanism is elasticized, pliable, adjustable, or any combination thereof.

5. A method according to claim 1, wherein the attachment mechanism allows for a large enough width to encompass a beverage container at the beverage container's widest point.

6. A method according to claim 4, wherein the attachment mechanism allows for a large enough width to encompass a beverage container at the beverage container's widest point.

7. A method according to claim 5, wherein the attachment mechanism includes at least one of a band, a strap, a sleeve, a wrapping or any combination thereof.

8. A method according to claim 7, wherein the attachment mechanism is either continuous or non-continuous with a means for clasping.

9. A method according to claim 1, further comprising placing the attachment mechanism on a beverage container.

10. A method according to claim 8, further comprising placing the attachment mechanism on a beverage container.

11. A method according to claim 9, further comprising placing the unique identifier on the attachment mechanism via a detachable fastening means that permits interchangeability of various unique identifiers with the attachment mechanism, and other unique identifiers are interchanged with the unique identifier; and wherein the detachable fastening means is either magnetic, composed of a male part affixed to either the band or the identity item and a female part affixed to the opposing end, a hook-shaped clasp fastened to either the band or the identity item which links through a circular piece attached to the opposing end, a ridged or threaded opening and an opposingly ridged and threaded insert, a threaded screw mechanism, a flexible plural-prong clip and a cylindrical attachment site, or any combination thereof.

12. A method according to claim 11, wherein the fastening means is composed of a barrel-type assembly such that either magnetism or friction maintains one end of the fastener within the other and detachment occurs by applying a pre-determined tension to overcome the magnetic or frictional force.

13. A method according to claim 10, further comprising a step of customizing the unique identifier at a retail point of sale by engraving, screen printing, or ink-jet printing.

14. A method according to claim 1, wherein the unique identifier emits a sound.

15. A method for uniquely identifying a beverage container, comprising the steps of:
a) providing an attachment mechanism to a beverage container;
b) providing a unique identifier for placement on the attachment mechanism; and
c) displaying the attachment mechanism, the unique identifier or both.

16. A method according to claim 15, wherein the displaying step is performed with:
a) the attachment mechanism and unique identifier attached to the beverage container during manufacture;
b) the attachment mechanism attached to the beverage container during manufacture and the unique identifier displayed and sold separately;
c) the attachment mechanism and the unique identifier displayed together as one unit, separately from the beverage container; or
d) the attachment mechanism and the unique identifier displayed separately from one another and from the beverage container.

17. A method according to claim 16, wherein the displaying step is performed via an internet website wherein a selection of attachment mechanisms and the unique identifiers are displayed both together and separately.

18. A method according to claim 17, wherein the displaying step is performed by allowing point-of-sale customization of the attachment mechanisms and unique identifiers.

19. A method according to claim 15, wherein the displaying step is performed by containing the bands and identity items in a portable display that facilitates temporary or permanent attachment to a counter, a wall, a rack or the like; and the displaying step is performed by containing the bands and identity items within separate partitions, wherein (i) transparent lids allow viewing of each partition; or (ii) opaque lids are adorned with an example of the band or identity item contained within each partition.

20. A method for uniquely identifying a beverage container, comprising the steps of:
a) providing an attachment mechanism to a beverage container, wherein the attachment mechanism:
i) is elasticized, pliable, adjustable or any combination thereof;
ii) allows for a large enough width to encompass a beverage container at the beverage container's widest point;
iii) includes at least one of a band, a strap, a sleeve, a wrapping or any combination thereof;
iv) is either continuous or non-continuous with a means for clasping;
b) providing a unique identifier for placement on the attachment mechanism, wherein the unique identifier is interchangeable with additional unique identifiers, wherein the attachment mechanism and the unique identifier are displayed separately from the beverage container;
c) placing the attachment mechanism on a beverage container;
d) placing the unique identifier on the attachment mechanism via a detachable fastening means that permits interchangeability of various unique identifiers with the attachment mechanism, and other unique identifiers are interchanged with the unique identifier; and wherein the detachable fastening means is either magnetic, composed of a male part affixed to either the band or the identity item and a female part affixed to the opposing end, a hook-shaped clasp fastened to either the band or the identity item which links through a circular piece attached to the opposing end, a ridged or threaded opening and an opposingly ridged and threaded insert, a threaded screw mechanism, a flexible plural-prong clip and a cylindrical attachment site, or any combination thereof.
